(19) United States
(12) Patent Application Publication
(10) Pub. No.: US 2006/0177214 A1
(43) Pub. Date: Aug. 10, 2006

(54) Image display device and image display program

(75) Inventor: Takashi Ozawa, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/322,546

(22) Filed: Jan. 3, 2006

(30) Foreign Application Priority Data
Jan. 26, 2005 (JP) 2005-017929

(51) Int. Cl. G03B 13/02

(52) U.S. Cl. 396/374

(57) ABSTRACT

An image display device includes: a storage device that stores a plurality of images; a display section; and a control section that reads out an image of interest from the storage device to make the display section display the image of interest, wherein when a first manipulation is performed with the image of interest displayed, the control section executes a first display process to make the display section display the image shot at a first shooting date before a shooting date of the image of interest, and when a second manipulation is performed with the image of interest displayed, the control section executes a second display process to make the display section display the image shot at a second shooting date after the shooting date of the image of interest.

### BACKGROUND

1. Technical Field

The present invention relates to an image display device including a control section that makes a display section display an image stored in a storage device, and an image display program that serves to operate the control section.

2. Related Art

As an image display device of this kind, there is known an image display device disclosed by JP-A-2003-299028. The image display device is incorporated in a digital camera, and serves to display a real time picture during picture taking and an image recorded on a memory card, etc. on a liquid crystal monitor. In this case, when two or more images are recorded on the memory card, the image display device calculates shooting intervals (time differences) in the date and time of shooting when images are shot, divides the images into blocks based on the shooting intervals, and displays an image (i.e. first shot image) located at the top of each block in thumbnail on a liquid crystal monitor. Therefore, it is possible to retrieve a desired image from among a large number of images referring to the so displayed images.

This is described in pp. 4-6, JP-A-2003-299028 with reference to FIGS. 2-3 thereof.

However, a conventional image display device has disadvantages as follows. That is, the image display device calculates shooting intervals of images when the images are divided into blocks. Therefore, in the case where a large number of images are recorded on a memory card, it takes much time to calculate the shooting intervals for all the images, which makes difficult to retrieve a desired image for a short time. In this case, for the purpose of shortening the time to calculate shooting intervals, an arrangement to store the calculated shooting intervals is disclosed by the above-described official gazette. However, the arrangement requires recalculation of the shooting intervals of all the images when some of the shot images are erased. Therefore, it is still difficult to retrieve a desired image for a short time. For example, when the shooting interval which is used as a reference in division into blocks is set to a shorter value, the number of the blocks is increased (i.e. the blocks are made smaller), which makes difficult to identify the block which contains a desired image.

### SUMMARY

A primary advantage of some aspects of the invention is to provide an image display device and an image display program, which makes it possible to retrieve a desired image to be displayed with a display section among two or more images readily for a short time.

An image display device according to an aspect of the invention includes: a storage device that stores a plurality of images; a display section; and a control section that reads out an image of interest from the storage device to make the display section display the image of interest, wherein when a first manipulation is performed with the image of interest displayed, the control section executes a first display process to make the display section display the image shot at a first shooting date before a shooting date of the image of interest, and when a second manipulation is performed with the image of interest displayed, the control section executes a second display process to make the display section display the image shot at a second shooting date after the shooting date of the image of interest.

An image display program includes the steps of: making a control section operate so as to read out an image of interest from a storage device that stores a plurality of images and make a display section display the read image; making the control section execute a first display process to make the display section display one of the images shot at a first shooting date before a shooting date of the image of interest when a first manipulation is performed with the image of interest displayed; and making the control section execute a second display process to make the display section display one of the images shot at a second shooting date after a shooting date of the image of interest when a second manipulation is performed with the image of interest displayed.

In the image display device and the image display program, the control section executes the first display process when the first manipulation is performed, and the control section executes the second display process when the second manipulation is performed. Therefore, the shooting date moves back by a day each time the first manipulation is performed once, and the shooting date moves forward by a day each time the second manipulation is performed. As a result, even when many pieces of image data shot at two or more dates are stored by the storage device, images of shooting dates can be switched and displayed by a minimized number of manipulations, using one image for each shooting date. Further, the control section switches and displays one image of each shooting date only based on the shooting date and time and as such, switching and display of the image can be performed for a short time unlike a conventional image display device in which the shooting intervals of images are calculated and then the images are divided into blocks based on the calculated shooting intervals. Therefore, with the image display device and the image display program, it is possible to retrieve a desired image, which is to be displayed by the display section, among two or more images readily for a short time.

In addition, an image display device according to an aspect of the invention includes: a storage device that stores a plurality of images; a display section; and a control section that reads out an image of interest from the storage device to make the display section display the image of interest, wherein when under the condition where the display section is made to display at least two of the images, the image of interest is selected from among the displayed images and a first manipulation is performed, the control section executes a first display process to make the display section display one of the images shot at a first shooting date before a shooting date of the selected image of interest in a predetermined location within the display section, and when under the condition where the display section is made to display at least two of the images, the image of interest is selected from among the displayed images and a second manipulation is performed, the control section executes a second display process to make the display section display one of the images shot at a second shooting date after the shooting date of the image of interest in the predetermined location.

In this image display device, the control section executes the first display process when the first manipulation is performed under the condition where one of the at least two displayed images is selected, and the control section executes the second display process when the second manipulation is performed under the condition where one of the at least two displayed images is selected. Therefore, even when many pieces of image data shot at two or more dates are stored by the storage device, it is possible to retrieve a desired image, which is to be displayed by the display section, from among the many images readily for a short time.

A image display device according to an aspect of the invention is the image display device, wherein in the first display process, the control section makes the display section display one of the first shot image and the last shot image of the images shot at the first shooting date, and in the second display process, the control section makes the display section display one of the first shot image and the last shot image of the images shot at the second shooting date.

In the image display device, the control section makes the display section display one of the first shot image and the last shot image shot at the first shooting date in the first display process, and the control section makes the display section display one of the first shot image and the last shot image shot at the second shooting date in the second display process. In general, in the case where two or more images were shot in a day, the first shot image or the last shot image would be the most impressive of the two or more images. Therefore, with the image display device, when a desired image is retrieved from among a large number of images recorded by the storage device and displayed, it is possible to make full use of the first shot or last shot image as a guide for retrieval.

### BRIEF DESCRIPTION OF THE DRAWINGS

The invention will be described with reference to the accompanying drawings, wherein like numbers reference like elements.

FIG. 1 is a block diagram showing a digital camera 1 in association with an embodiment of the invention.

FIG. 2 is a rear view of the digital camera 1.

FIG. 3 is a conceptual illustration conceptually showing a condition where image data Db1-Db19 are recorded on a memory card 101.

FIG. 4 is a conceptual illustration conceptually showing a date-table including date data Dd1-Dd8.

FIG. 5 is an illustration showing display screens that display images G16-G19.

FIG. 6 is a flow chart of a pointer-move process 50 in association with the embodiment.

FIG. 7 is a flow chart of a preceding day's image display process 60 in association with the embodiment.

FIG. 8 is an illustration showing display screens that display images G14, G11, G6 and G5.

FIG. 9 is a flow chart of a subsequent day's image display process 70 in association with the embodiment.

FIG. 10 is an illustration showing display screens that display images G6, G11, G14 and G16.

FIG. 11 is an illustration showing display screens that display images G11-G19 in thumbnail.

FIG. 12 is an illustration showing display screens that display images G6-G14 in thumbnail.

### DESCRIPTION OF EXEMPLARY EMBODIMENTS

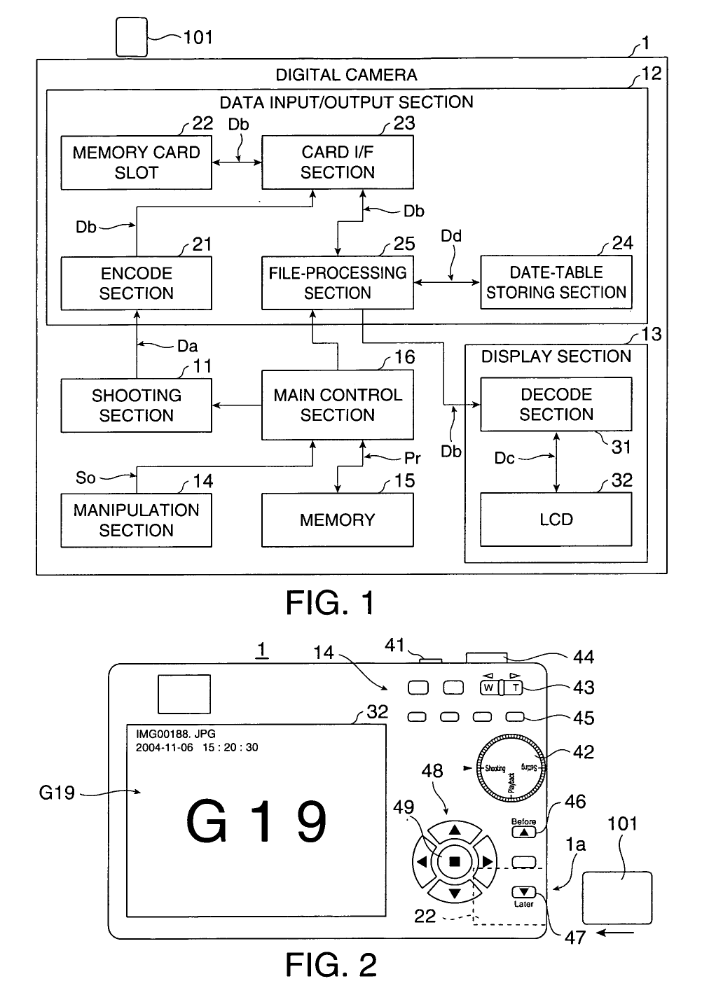

The best modes of an image display device and image display program according to the invention will be described below with reference to the accompanying drawings. The digital camera 1 shown in FIG. 1 is the one which is equipped with the image display device according to the invention. The digital camera 1 includes: a shooting section 11; a data input/output section 12; a display section 13; a manipulation section 14; a memory 15; and a main control section 16. In this case, the data input/output section 12, display section 13, manipulation section 14, memory 15 and main control section 16 constitute the image display device according to the invention. The shooting section 11 creates photographed data Da and outputs to the data input/output section 12 under the control of the main control section 16. The shooting section 11 includes an optical system including a lens, photoelectric elements such as a CCD and CMOS, etc. However, to make the description of the invention clearly understandable, their illustrations and descriptions are omitted.

The data input/output section 12 includes: an encode section 21; a memory card slot 22; a card I/F section 23; a date-table storing section 24; and a file-processing section 25, as shown in FIG. 1. The encode section 21 encodes photographed data Da output by the shooting section 11 into e.g. JPEG-format image data Db and outputs to the card I/F section 23. In this case, the encode section 21 assigns a file name (data name) to the image data Db and concurrently prepares the image data dB so that it contains the date and time when the photographed data Da was created, i.e. shooting date and time when the picture was taken. The memory card slot 22 is made so that it can be connected with a memory card 101 (FIG. 2) inserted through an insertion opening 1a (FIG. 2) formed in the main body of the digital camera 1, for example. In this case, the memory card 101 represents the storage device in the invention. As an example, the memory card 101 is made so that it can record (store) JPEG-format image data, etc. The card I/F section 23 writes image data Db into the memory card 101 connected to the memory card slot 22, and reads the image data Db from the memory card 101 under the control of the file-processing section 25.

The date-table storing section 24 stores a date-table conceptually shown in FIG. 4. In this case, the date-table is made up of date data Dd including a shooting date that the image data Db contains and a file name of the image data Db. The file-processing section 25 controls the card I/F section 23 under the control of the main control section 16. Also, when an image is reproduced, the file-processing section 25 outputs the image data Db, which is read out by the card I/F section 23, to the display section 13 and concurrently executes an image display process, a date data-writing process, a preceding day's image display process 60, and a subsequent day's image display process 70, which are to be described later.

The display section 13 includes a decode section 31 and an LCD (Liquid Crystal Display) 32, as shown in FIG. 1. The decode section 31 decodes JPEG-format image data Db into image data Dc for display and outputs to the LCD 32. The LCD 32 is provided in place on a rear face of the main body of the digital camera 1, as shown in FIG. 2, and displays an image (e.g. the image G19 shown in FIG. 2, which is hereinafter also referred to as “image G” when it is not necessary to differentiate what the images express) based on the image data Dc that the decode section 31 outputs.

The manipulation section 14 has various kinds of switches and keys arranged therein, including a power-on switch 41, a mode-selecting switch 42, a zoom switch 43, a shutter switch 44, a display changeover switch 45, a date-back switch 46, a date-forward switch 47, a cursor key 48, and a decision key 49, as shown in FIG. 2. When those are manipulated, the manipulation section 14 outputs a manipulation signal Sₒ to the main control section 16. The memory 15 includes a nonvolatile memory such as an EPROM. In this case, a program Pr for activation of the main control section 16 including the image display program according to the invention is recorded in the memory 15.

The main control section 16 constitutes the control section in the invention together with the file-processing section 25, and is activated according to the program Pr recorded in the memory 15. Also, the main control section 16 controls the shooting section 11 and the data input/output section 12 according to the manipulation signal Sₒ that the manipulation section 14 outputs.

Now, a method to photograph a subject using the digital camera 1 will be described with reference to the drawings. First, as shown in FIG. 2, a memory card 101 is inserted into the memory card slot 22 of the data input/output section 12 through the insertion opening 1a of the digital camera 1. Second, the power-on switch 41 of the manipulation section 14 is manipulated, and then the mode-selecting switch 42 is manipulated to select “Shooting” mode. Thereafter, the main control section 16 reads the program Pr from the memory 15 and starts controlling the shooting section 11 according to a manipulation signal Sₒ output by the manipulation section 14. Subsequently, the zoom switch 43 of the manipulation section 14 is manipulated to zoom. At this step, the shooting section 11 carries out the process of zooming under the control of the main control section 16. Then, the shutter switch 44 of the manipulation section 14 is manipulated. At this step, the shooting section 11 carries out the process of shooting and outputs photographed data Da to the data input/output section 12 under the control of the main control section 16.

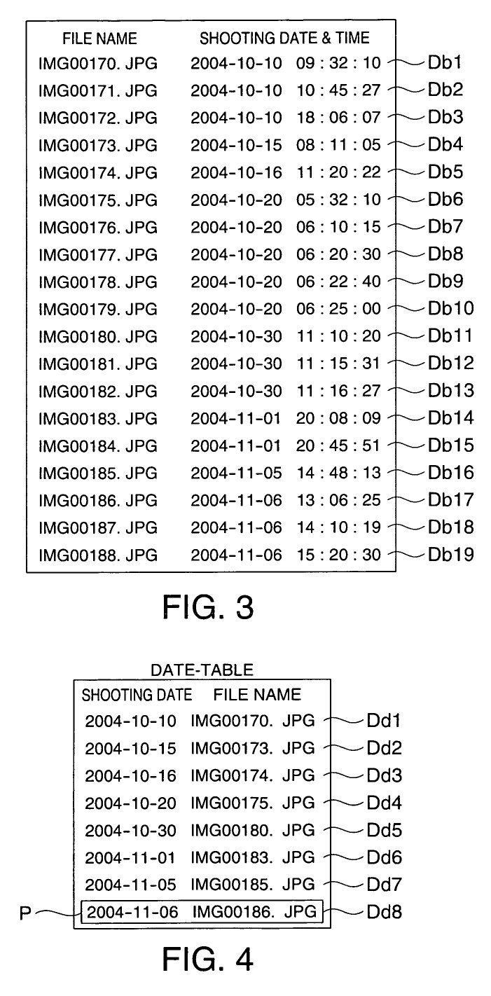

Subsequently, the encode section 21 of the data input/output section 12 encodes the photographed data Da into JPEG-format image data Db and outputs to the card I/F section 23. In this case, the encode section 21 assigns a file name to the image data Db so that the assigned file name does not coincide with a file name that has been already recorded on the memory card 101. Concurrently, the image data Db is prepared so as to contain a shooting date and time. Subsequently, the file-processing section 25 controls the card I/F section 23 to make the section 23 write the image data Db on the memory card 101 connected to the memory card slot 22 under the control of the main control section 16. After that, each time the shutter switch 44 is manipulated, the shooting section 11 and the data input/output section 12 carry out the above-described operations (processes) repeatedly. Thus, the image data Db (e.g. pieces of image data Db1-Db19 in FIG. 3) are recorded on the memory card 101 in the order of shooting date, as conceptually shown in FIG. 3.

Next, a method to make the digital camera 1 display an image G based on the image data Db recorded on the memory card 101 will be described with reference to the drawings. First, the memory card 101 is inserted into the memory card slot 22 of the digital camera 1 in the same way as described above. Subsequently, the power-on switch 41 of the manipulation section 14 is manipulated, and then the mode-selecting switch 42 is manipulated to select “Reproduction” mode. At this step, the main control section 16 reads the program Pr from the memory 15 according to a manipulation signal Sₒ output by the manipulation section 14. Subsequently, the main control section 16 controls the file-processing section 25 in the data input/output section 12 to make the section 25 carry out the image display process according to the program Pr. In the image display process, the file-processing section 25 controls the card I/F section 23 to make the section 23 read out the image data Db recorded on the memory card 101.

Next, the file-processing section 25 inputs the image data Db through the card I/F section 23 thereto and carries out the date data-writing process. In the date data-writing process, as conceptually shown in FIG. 4, the file-processing section 25 extracts a file name of each image data Db and a shooting date that the image data Db contains, creates e.g. date data Dd1-Dd8 (hereinafter also referred to as “date data Dd” when it is not necessary to differentiate them), and writes the data into the date-table held in the date-table storing section 24. In this case, when the memory card 101 has therein two or more pieces of image data Db each containing the same shooting date, i.e. when two or more images were shot on the same day, the file-processing section 25 writes into the date-table, for example, only the date data Dd involved in image data Db (crosshatched image data Db shown in FIG. 3) having an earliest shooting time among the two or more image data Db.

Subsequently, as conceptually shown in FIG. 4, the file-processing section 25 sets a pointer P on e.g. the date data Dd (date data Dd8 in this case) containing the last shooting date in the date-table. Subsequently, the file-processing section 25 controls the card I/F section 23 to make the section 23 read out e.g. the image data Db19, which was recorded last, from the memory card 101. Then, the file-processing section 25 outputs the image data Db19 to the decode section 31 of the display section 13. Subsequently, the decode section 31 decodes the image data Db19 into image data Dc for display and outputs to the LCD 32. Thus, as shown in FIG. 2, the LCD 32 displays the image G19 based on the image data Dc that was shot last.

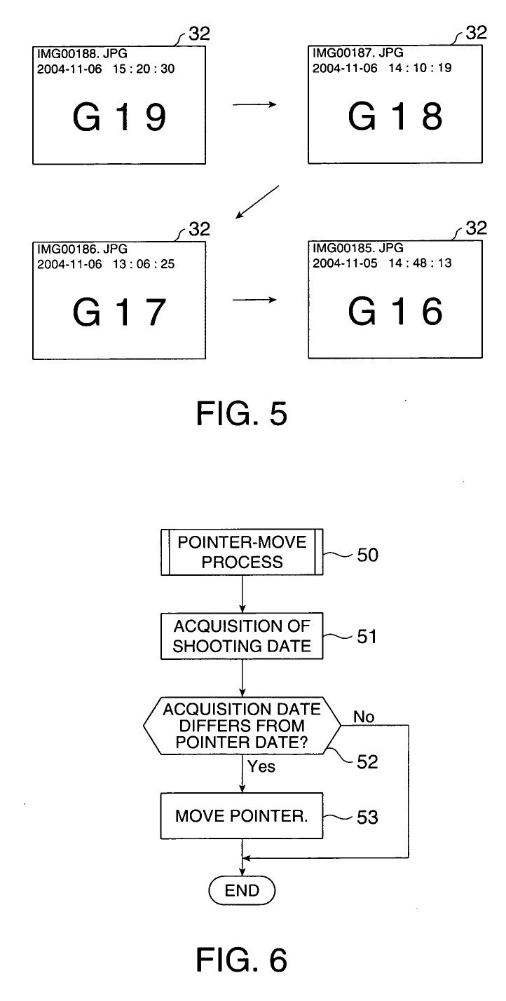

Subsequently, when the image G that has been shot just before the image G19 is displayed instead of the image G19, the up arrow key of the cursor key 48 in the manipulation section 14 is manipulated (see FIG. 2). At this step, under the control of the main control section 16, the file-processing section 25 controls the card I/F section 23, makes the section 23 read out the image data Db18 (FIG. 3) from the memory card 101 that was recorded just before the recording of the image data Db19, and outputs the read image data Db18 to the decode section 31. Then, the decode section 31 decodes the image data Db18 into image data Dc and outputs to the LCD 32. Thus, the LCD 32 displays the image G18 based on the image data Db18 instead of the image G19, as shown in an upper portion of FIG. 5.

In addition, the file-processing section 25 executes a pointer-move process 50 shown in FIG. 6, when the cursor key 48 is manipulated. In the pointer-move process 50, the file-processing section 25 acquires a shooting date that the image data Db (image data Db18 in this case) newly read out by the card I/F section 23 contains, as shown in the drawing (Step 51). Subsequently, the file-processing section 25 judges whether or not the acquired shooting date (hereinafter also referred to as “acquisition date”) differs from the shooting date (hereinafter also referred to as “pointer date”) of the date data Dd (date data Dd8 in this case) on which the pointer P is set in the date table before the manipulation of the cursor key 48 (Step 52). In this case, when the acquisition date differs from the pointer date, the file-processing section 25 moves the pointer P to the date data Dd containing the acquisition date (Step 53). Further, when the acquisition date coincides with the pointer date, the pointer-move process 50 is terminated without moving the pointer P. After that, the file-processing section 25 carries out the above-described process each time the up arrow key of the cursor key 48 is manipulated. Thus, the image G is switched and displayed on the LCD 32 in the order reverse to that of the shooting date each time the up arrow key of the cursor key 48 is manipulated, as shown in FIG. 5. Also, when the down arrow key (FIG. 2) of the cursor key 48 is manipulated, the file-processing section 25 switches and displays the image G on the LCD 32 in the order reverse to the above-described order. Thus, the image G is switched and displayed on the LCD 32 in the order of the shooting date each time the down arrow key of the cursor key 48 is manipulated.

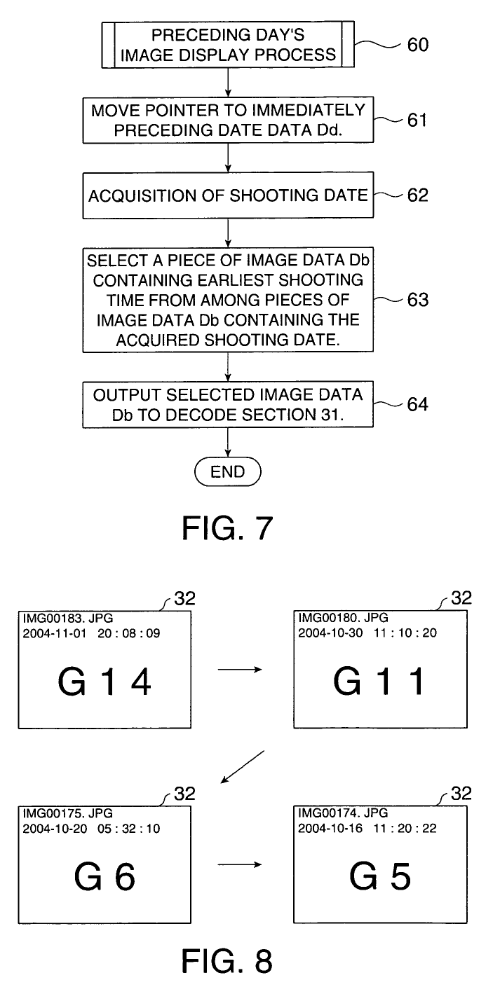

Now, for example, under the condition where the image G16 is displayed as shown in FIG. 5, when an image G that has been shot at a shooting date (first shooting date in the invention) before the shooting date of the image G16 is displayed, the date-back switch 46 in the manipulation section 14 is manipulated (first manipulation in the invention). In this manipulation, the file-processing section 25 executes the preceding day's image display process 60 (first process in the invention) shown in FIG. 7 under the control of the main control section 16. In the preceding day's image display process 60, the file-processing section 25 moves the pointer P, based on the date-table recorded in the date-table storing section 24, from the date data Dd on which the pointer P had been set just before manipulation of the date-back switch 46 (e.g. date data Dd7 shown in FIG. 4) to the date data Dd designating the shooting date just before the shooting date designated by the date data. Dd on which the pointer P had been set, i.e. the immediately preceding date data Dd (the date data Dd6 shown in FIG. 4) (Step 61). Subsequently, the file-processing section 25 acquires the shooting date (Nov. 1, 2004, in this case) of the date data Dd6 to/on which the pointer P has been moved/set (Step 62).

Subsequently, the file-processing section 25 selects a piece of image data Db (image data Db14 shown in FIG. 3) containing the earliest shooting time among pieces of image data Db (image data Db14, Db15 shown in the drawing) that contain the acquired shooting date (Step 63). Then, the file-processing section 25 controls the card I/F section 23 to make the section 23 read the image data Db14 from the memory card 101, and concurrently outputs the image data Db14 to the decode section 31 (Step 64). Subsequently, decode section 31 decodes the image data Db14 into image data Dc and outputs to the LCD 32, whereby the image G14 is displayed on the LCD 32 as shown in an upper left portion of FIG. 8. Here, the image G14 is the one having the earliest shooting time of the images G shot at the date before the shooting date of the image G16 that has been displayed immediately before manipulation of the date-back switch 46. More specifically, image G14 is the one shot at the earliest time of the images shot on the day designated by the shooting date. (Hereinafter, of the images G shot at the same shooting date, the image G shot at the earliest time is also referred to as “top image G”). After that, the file-processing section 25 carries out the preceding day's image display process 60 each time the date-back switch 46 is manipulated. Thus, as shown in FIG. 8, the shooting date moves back each time the date-back switch 46 is manipulated. Therefore, the top images G (images G11, G6, G5 shown in FIG. 8) of the shooting date after the back moving manipulations are switched and displayed on the LCD 32. In this case, the shooting date moves back by a day each time the date-back switch 46 is manipulated once. Therefore, even when many pieces of image data Db shot at two or more dates are recorded on the memory card 101, the top images G of the shooting dates can be switched and displayed by a minimized number of manipulations. Further, the file-processing section 25 switches and displays the top image G of each shooting date only based on the shooting date and time and as such, switching and display of the image G can be performed for a short time unlike a conventional image display device in which the shooting intervals of images G are calculated and then the images G are divided into blocks based on the calculated shooting intervals.

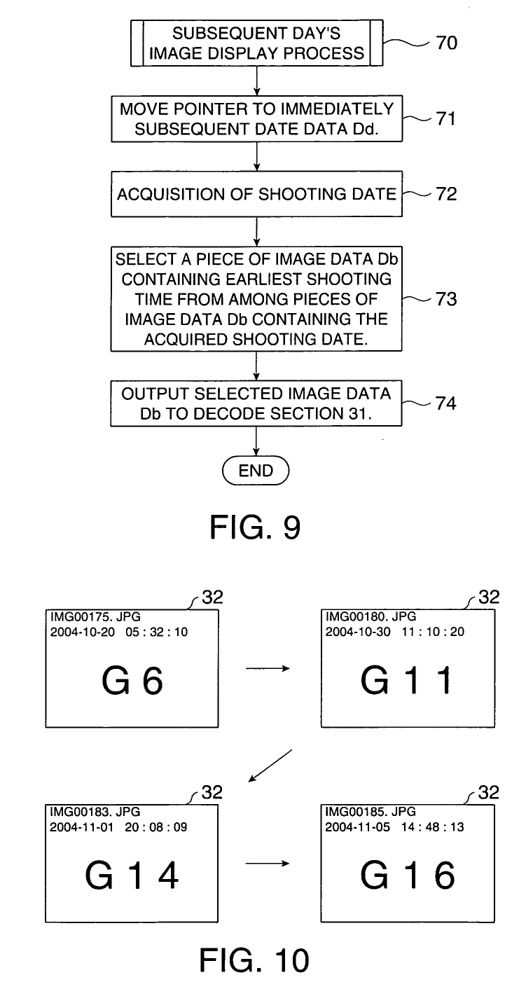

Subsequently, for example, under the condition where the image G5 is displayed as shown in FIG. 8, when an image G shot at a shooting date (second shooting date in the invention) after the shooting date of the image G5 is displayed, the date-forward switch 47 in the manipulation section 14 is manipulated (second manipulation in the invention). In this manipulation, the file-processing section 25 carries out the subsequent day's image display process 70 (second process in the invention) shown in FIG. 9 under the control of the main control section 16. In the subsequent day's image display process 70, the file-processing section 25 moves the pointer P from the date data Dd (e.g. date data Dd3 shown in FIG. 4) on which the pointer P had been set just before manipulation of the date-forward switch 47 to the date data Dd designating the shooting date immediately after the shooting date designated by the date data Dd on which the pointer P had been set, namely the immediately subsequent date data Dd (e.g. date data Dd4 shown in FIG. 4) in the date-table recorded in the date-table storing section 24 (Step 71). Then, the file-processing section 25 acquires the shooting date (Oct. 20, 2004, in this case) of the date data Dd4 to/on which the pointer P is moved/set (Step 72).

Next, the file-processing section 25 selects a piece of image data Db (image data Db6 shown in FIG. 3) containing the earliest shooting time among pieces of image data Db (image data Db6-Db10 shown in the drawing) that contain the acquired shooting date (Step 73). Subsequently, the file-processing section 25 controls the card I/F section 23 to make the section 23 read out the image data Db6 from the memory card 101, and concurrently outputs the read image data Db6 to the decode section 31 (Step 74). After that, the decode section 31 decodes the image data Db6 into image data Dc and outputs the resulting data to the LCD 32, whereby the image G6 is displayed on the LCD 32 as shown in an upper left portion of FIG. 10. Here, the image G6 is the one having the earliest shooting time of the images G shot at the date after the shooting date of the image G5 that had been displayed immediately before manipulation of the date-forward switch 47, i.e. the top image of the shooting date after the shooting date of the image G5. After that, the file-processing section 25 carries out the subsequent day's image display process 70 each time the date-forward switch 47 is manipulated. Thus, as shown in FIG. 10, the shooting date moves forward each time the date-forward switch 47 is manipulated. Therefore, then the top images G (images G11, G14, G16 shown in FIG. 10) of the shooting dates after the forward moving manipulations are switched and displayed on the LCD 32. In this case, the shooting date moves forward by a day each time the date-forward switch 47 is manipulated once, as in the case of the above-described preceding day's image display process 60. Therefore, the top images G of shooting dates can be switched and displayed for a short time by a minimized number of manipulations. The image G that is switched and displayed by the preceding day's image display process 60 and the subsequent day's image display process 70 is not limited to the top image G. It may be any one of the images G shot at the shooting dates after the back moving or forward moving. For example, the image G shot at the latest time of images shot at the shooting date after the back moving or forward moving may be displayed instead of the top image G.

Subsequently, it is confirmed whether or not there is a top image G that seems to have been shot at the same day as a desired image G is taken, for example, of top images G displayed by manipulating the date-back switch 46 and the date-forward switch 47. In the confirmation, when such top image G is found out, the down arrow key of the cursor key 48 is manipulated to switch and display images G of the shooting date in turn while the top image G is kept displayed. Thus, it becomes possible to readily retrieve and display a desired image G for a short time.

As described above, with the digital camera 1 and the image display program, the file-processing section 25 executes the preceding day's image display process 60 when the date-back switch 46 is manipulated, and the file-processing section 25 carries out the subsequent day's image display process 70 when the date-forward switch 47 is manipulated. Then, the shooting date moves back by a day each time the date-back switch 46 is manipulated once, and moves forward by a day each time the date-forward switch 47 is manipulated once. Therefore, even when many pieces of image data Db shot at two or more dates have been recorded on the memory card 101, the images G can be switched and displayed by a minimized number of manipulations, using one of the images G shot at each shooting date. In addition, the file-processing section 25 displays one image G for each shooting date and switches the image based on only the shooting date and time and as such, the image display and switching can be carried out for a short time unlike a conventional image display device which calculates the shooting intervals between images G and divides the images G into blocks based on the calculated shooting intervals. Therefore, the digital camera 1 and the image display program make possible to retrieve a desired image G to be displayed on the LCD 23 from among two or more images G readily for a short time.

Also, in the preceding day's image display process 60, the file-processing section 25 makes the display section 13 display the top image G of the day before the shooting date of the image G that had been displayed just before manipulation of the date-back switch 46, whereas in the subsequent day's image display process 70, the file-processing section 25 makes the display section 13 display the top image G of the day after the shooting date of the image G that had been displayed just before manipulation of the date-forward switch 47. In general, in the case where two or more images were shot in a day, the top image G would be the most impressive of the two or more images G. Therefore, with the digital camera 1 and the image display program, when a desired image G is retrieved from among a large number of images G recorded on the memory card 101 and displayed, it is possible to make full use of the top image G as a guide for retrieval.

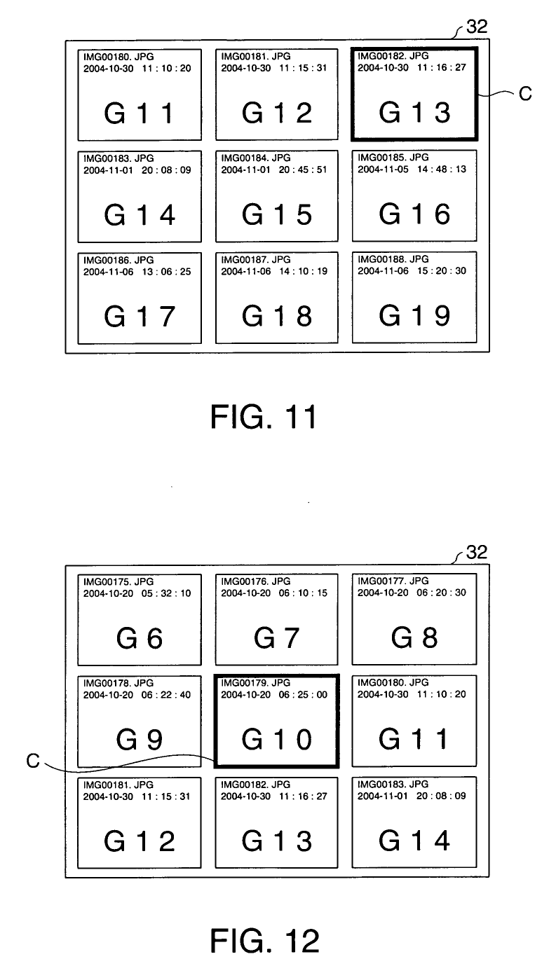

The invention is not limited to the above-described arrangement. For example, although an example in which LCD 32 displays one image G in full screen has been described, it is also possible to adopt an arrangement such that the LCD 32 displays two ore more images in thumbnail. With such arrangement, for example, when the display changeover switch 45 of the manipulation section 14 is manipulated, the main control section 16 controls the file-processing section 25 in the data input/output section 12 to execute the image display process for thumbnail display according to a manipulation signal Sₒ output from the manipulation section 14. In this case, the file-processing section 25 controls the card I/F section 23 and make the section 23 read out, from the memory card 101, e.g. nine pieces of image data Db (as an example, image data Db11-Db19 shown in FIG. 3) which are newer in shooting date and time. Next, the file-processing section 25 synthesizes the image data Db for thumbnail display and outputs the resulting data to the decode section 31 in the display section 13. Subsequently, the decode section 31 decodes the synthesized image data Db into image data Dc for display and outputs the image data Dc to the LCD 32. Thus, for example, nine images G11-G19 are displayed on the LCD 32 in thumbnail as shown in FIG. 11.

Subsequently, for example, when the cursor key 48 of the manipulation section 14 is manipulated to select, by a cursor C, one image (e.g. image G13 shown in FIG. 11) of images G displayed in thumbnail as shown in the drawing, the file-processing section 25 executes the same processing as that in the above-described pointer-move process 50. In this case, when the shooting date (acquisition date) that the image data Db corresponding to the selected image G contains differs from the shooting date (pointer date) that the date data Dd in the date-table on which the pointer P had been set before the manipulation of the cursor key 48 contains, the file-processing section 25 moves the pointer P to the date data Dd that contains the acquisition date. Next, the date-back switch 46 is manipulated in the condition where the image G13 is selected, the file-processing section 25 executes the same processing as that of the preceding day's image display process 60. In this case, the file-processing section 25 moves the pointer P, in the date-table held in the date-table storing section 24, from the date data Dd (date data Dd5 shown in FIG. 4) containing the shooting date of the selected image G13 to the date data Dd designating the shooting date just before the shooting date designated by the date data Dd in association with the image G13, namely immediately preceding date data Dd (date data Dd4 shown in FIG. 4). Then, the file-processing section 25 acquires the shooting date (Oct. 20, 2004 in this case) of the date data Dd4. Subsequently, the file-processing section 25 selects a piece of image data Db (image data Db6 in FIG. 3) containing the earliest shooting time from among pieces of image data Db (image data Db6-Db10 shown in FIG. 3) containing the acquired shooting date. After that, the file-processing section 25 controls the card I/F section 23 to make the section 23 read out, from the memory card 101, nine pieces of image data Db (image data Db6-Db14 in FIG. 3) in the order of lapse of shooting date and time starting from the image data Db6. Subsequently, the file-processing section 25 synthesizes the image data Db for thumbnail display and outputs the resulting data to the decode section 31 in the display section 13. Further subsequently, the decode section 31 decodes the synthesized image data Db into image data Dc for display and outputs the resulting data to the LCD 32. Thus, the LCD 32 displays nine images G6-G14 in thumbnail in the order of lapse of shooting date and time e.g. from an upper left corner portion (a predetermined location in the invention) in a display screen of the LCD 32 as shown in FIG. 12.

Now, for example, when the date-forward switch 47 is manipulated in the condition where one of (e.g. image G10 in FIG. 12) images G displayed in thumbnail is selected with the cursor C by manipulating the cursor key 48 of the manipulation section 14 as shown in FIG. 12, the file-processing section 25 executes the same processing as that in the above-described subsequent day's image display process 70. In this case, the file-processing section 25 moves the pointer P, in the date table held in the date-table storing section 24, from the date data Dd (e.g. date data Dd4 shown in FIG. 4) containing the shooting date of the selected image G10 to the date data Dd designating the shooting date immediately after the shooting date designated by the date data Dd in association with the image G10, namely the immediately subsequent date data Dd (date data Dd5 shown in FIG. 4). Then, the file-processing section 25 acquires the shooting date (Oct. 30, 2004 in this case) of the date data Dd5. Next, the file-processing section 25 selects a piece of image data Db (image data Db11 shown in FIG. 3) containing the earliest shooting time from among pieces of image data Db (image data Db11-Db13 shown in FIG. 3) containing the acquired shooting date. After that, the file-processing section 25 controls the card I/F section 23 to make the section 23 read out, from the memory card 101, nine pieces of image data Db (image data Db11-Db19 shown in FIG. 3) in the order of lapse of shooting date and time starting from the image data Db11. Subsequently, the file-processing section 25 synthesizes image data Db for thumbnail display and outputs the resulting data to the decode section 31 in the display section 13. Then, the decode section 31 decodes the synthesized image data Db into image data Dc for display and outputs the resulting data to the LCD 32. Thus, the LCD 32 displays nine images G11-G19 in thumbnail in the order of lapse of shooting date and time e.g. from the upper left corner portion (the predetermined location in the invention) in the display screen of the LCD 32. Also, another arrangement may be adopted, in which two or more images G are displayed in thumbnail in the order reverse to the order of lapse of shooting date and time with the image G having the latest shooting time at the acquired shooting date located at the top.

Next, for example, when a desired image G is found among the images G11-Gl9 displayed in thumbnail, the cursor key 48 is manipulated to select the desired image G with the cursor C. In this situation, the decision key 49 (FIG. 2) is manipulated. In this operation, the file-processing section 25 controls the card I/F section 23 to make the section read out the image data Db corresponding to the selected image G from the memory card 101, and outputs the read image data Db to the decode section 31 under the control of the main control section 16. Then, the decode section 31 decodes the image data Db into image data Dc and outputs the resulting data to the LCD 32, whereby the desired image G selected under the condition where it is displayed in thumbnail is displayed on the LCD 32 in full screen.

With this arrangement, the file-processing section 25 is made to execute the same processing as that in the preceding day's image display process 60 when the date-back switch 46 is manipulated under the condition where one of two or more images G displayed in thumbnail is selected. In addition, the file-processing section 25 is made to execute the same processing as that in the subsequent day's image display process 70 when the date-forward switch 47 is manipulated under the condition where one of two or more images G displayed in thumbnail is selected. Therefore, even when many pieces of image data Db shot at two or more dates are recorded on the memory card 101 as in the case of the digital camera 1, it is possible to retrieve a desired image G to be displayed on the LCD 32 among the many images G readily for a short time.

According to the above-described arrangement, an image G shot at the immediately preceding shooting date is displayed when the date-back switch 46 is manipulated, and an image G shot at the immediately subsequent shooting date is displayed when the date-forward switch 47 is manipulated. However, another arrangement may be adopted, in which the shooting date of an image G, which is to be switched and displayed, is moved back or forward by two ore more days (e.g. 10 days) by manipulating a shift key (not shown) or the like concurrently with manipulating the switches 46, 47, for example. Further, while the example to display an image G based on image data Db recorded on the memory card 101 has been described above, what the image data Db is recorded on is not limited to the memory card 101. It is possible to display images G based on image data Db recorded on various kinds of memory elements and recording media, such as a memory, CD, DVD, hard disk, etc. In this case, these memory elements and recording media may be separated from or incorporated in the digital camera 1. Further, the example of executing the date data-writing process when the mode is switched from Shooting mode to Reproduction mode has been described above. However, another arrangement such that the date data-writing process is executed each time image data Db is output from the encode section 21 in Shooting mode may be adopted. Still further, while the example in which the invention is applied to a digital camera 1 has been described above, the invention may be applied to various kinds of electronic equipment, such as television sets, video recorders, printers, and portable terminals.

The entire disclosure of Japanese Patent Application No. 2005-17929, filed Jan. 26, 2005 is expressly incorporation by reference

What is claimed is:

1. An image display device, comprising:
a storage device that stores a plurality of images;
a display section; and
a control section that reads out an image of interest from the storage device to make the display section display the image of interest,
wherein when a first manipulation is performed with the image of interest displayed, the control section executes a first display process to make the display section display the image shot at a first shooting date before a shooting date of the image of interest, and
when a second manipulation is performed with the image of interest displayed, the control section executes a second display process to make the display section display the image shot at a second shooting date after the shooting date of the image of interest.

2. An image display device, comprising:
a storage device that stores a plurality of images;
a display section; and
a control section that reads out an image of interest from the storage device to make the display section display the image of interest,
wherein when under the condition where the display section is made to display at least two of the images, the image of interest is selected from among the displayed images and a first manipulation is performed, the control section executes a first display process to make the display section display one of the images shot at a first shooting date before a shooting date of the selected image of interest in a predetermined location within the display section, and
when under the condition where the display section is made to display at least two of the images, the image of interest is selected from among the displayed images and a second manipulation is performed, the control section executes a second display process to make the display section display one of the images shot at a second shooting date after the shooting date of the selected image of interest in the predetermined location.

3. The image display device of claim 1, wherein in the first display process, the control section makes the display section display one of the first shot image and the last shot image of the images shot at the first shooting date, and
in the second display process, the control section makes the display section display one of the first shot image and the last shot image of the images shot at the second shooting date.

4. An image display program, comprising the steps of:
making a control section operate so as to read out an image of interest from a storage device that stores a plurality of images and make a display section display the read image;
making the control section execute a first display process to make the display section display one of the images shot at a first shooting date before a shooting date of the image of interest when a first manipulation is performed with the image of interest displayed; and
making the control section execute a second display process to make the display section display one of the images shot at a second shooting date after a shooting date of the image of interest when a second manipulation is performed with the image of interest displayed.
